(19) United States
(12) Patent Application Publication
(10) Pub. No.: US 2021/0375246 A1
(43) Pub. Date: Dec. 2, 2021

(54) METHOD, DEVICE, AND STORAGE MEDIUM FOR GENERATING VOCAL FILE

(71) Applicant: BEIJING DAJIA INTERNET INFORMATION TECHNOLOGY CO., LTD., Beijing (CN)

(72) Inventors: Chun Chen, Beijing (CN); Chuang Niu, Beijing (CN)

(21) Appl. No.: 17/137,716

(22) Filed: Dec. 30, 2020

(30) Foreign Application Priority Data
May 28, 2020 (CN) 202010470013.0

(51) Int. Cl. G10H 1/36; G10H 1/00; G10H 7/00

(52) U.S. Cl. CPC G10H 1/368; G10H 1/0033; G10H 2250/455; G10H 7/004; G10H 1/0008

(57) ABSTRACT

The disclosure can provide a method, an electronic device, and a storage medium for generating a vocal file. The method can include the following. A recording control is displayed on a playing interface in response to a video played on the playing interface being a first type. A recording interface is displayed in response to the recording control being triggered. A user audio is recorded on the recording interface based on a target song. The vocal file is generated based on the user audio and the target song.

### CROSS-REFERENCE TO RELATED APPLICATION

This application is based on and claims priority to Chinese Patent Application No. 202010470013.0 filed on May 28, 2020, the disclosure of which is hereby incorporated herein by reference.

### FIELD

The disclosure relates to the field of audio and video processing technologies, and more particularly, to a method, an electronic device, and a storage medium for generating a vocal file.

### BACKGROUND

Karaoke software may be installed in terminal devices and record singing of users conveniently. In related arts, when a user wants to record his/her singing based on a song played on a playing interface of software, he/she needs to know a song name, enters a search interface of software, and inputs the song name into the search interface. The search interface returns audios corresponding to the song name. The user selects one from the audios and records his/her singing based on the selected audio. This manner has a complicated path.

### SUMMARY

According to embodiments of the disclosure, a method for generating a vocal file is provided. The method includes: displaying a recording control on a playing interface in response to a video being a first type, in which the video is played on the playing interface; displaying a recording interface in response to the recording control being triggered; recording a user audio on the recording interface based on a target song; and generating the vocal file based on the user audio and the target song.

According to embodiments of the disclosure, an electronic device is provided. The electronic device includes a processor and a storage device configured to store instructions executable by the processor. The processor is configured to execute the instructions to: display a recording control on a playing interface in response to a video being a first type, in which the video is played on the playing interface; display a recording interface in response to the recording control being triggered; record a user audio on the recording interface based on a target song; and generate the vocal file based on the user audio and the target song.

According to embodiments of the disclosure, a computer-readable storage medium is provided. The computer-readable storage medium has stored therein instructions that, when executed by a processor of an electronic device, causes the electronic device to carry out: displaying a recording control on a playing interface in response to a video being a first type, in which the video is played on the playing interface; displaying a recording interface in response to the recording control being triggered; recording a user audio on the recording interface based on a target song; and generating the vocal file based on the user audio and the target song.

The above general description and the following detailed description are exemplary and explanatory, and cannot limit the disclosure.

### BRIEF DESCRIPTION OF THE DRAWINGS

The drawings herein are incorporated into the specification and form a part of the specification, illustrating embodiments consistent with the disclosure and used together with the specification to explain the principles of the disclosure, and do not constitute undue limitations to the disclosure.

FIG. 1 is a flowchart illustrating a method for generating a vocal file according to some embodiments of the disclosure.

FIG. 2 is a schematic diagram illustrating an interactive interface of a method for generating a vocal file according to some embodiments of the disclosure.

FIG. 3 is a flowchart illustrating a method for generating a vocal file according to some embodiments of the disclosure.

FIG. 4 is a schematic diagram illustrating an interactive interface of a method for generating a vocal file according to some embodiments of the disclosure.

FIG. 5 is a flowchart illustrating a method for generating a vocal file according to some embodiments of the disclosure.

FIG. 6 is a schematic diagram illustrating an interactive interface of a method for generating a vocal file according to some embodiments of the disclosure.

FIG. 7 is a flowchart illustrating a method for generating a vocal file according to some embodiments of the disclosure.

FIG. 8 is a schematic diagram illustrating an interactive interface of a method for generating a vocal file according to some embodiments of the disclosure.

FIG. 9 is a flowchart illustrating a method for generating a vocal file according to some embodiments of the disclosure.

FIG. 10 is a flowchart illustrating a method for generating a vocal file according to some embodiments of the disclosure.

FIG. 11 is a schematic diagram illustrating an interactive interface of a method for generating a vocal file according to some embodiments of the disclosure.

FIG. 12 is a flowchart illustrating a method for generating a vocal file according to some embodiments of the disclosure.

FIG. 13 is a schematic diagram illustrating an interactive interface of a method for generating a vocal file according to some embodiments of the disclosure.

FIG. 14 is a flowchart illustrating a method for generating a vocal file according to some embodiments of the disclosure.

FIG. 15 is a schematic diagram illustrating an interactive interface of a method for generating a vocal file according to some embodiments of the disclosure.

FIG. 16 is a block diagram illustrating an apparatus for generating a vocal file according to some embodiments of the disclosure.

FIG. 17 is a block diagram illustrating an apparatus for generating a vocal file according to some embodiments of the disclosure.

FIG. 18 is a block diagram illustrating an electronic device according to some embodiments of the disclosure.

### DETAILED DESCRIPTION

In order to enable those of ordinary skill in the art to better understand technical solutions of the disclosure, technical solutions in embodiments of the disclosure will be described clearly and completely as follows with reference to the drawings.

It should be noted that terms “first” and “second” in the specification and claims of the disclosure and the above-mentioned drawings are used to distinguish similar objects, and are not necessarily used to describe a specific sequence or order. It should be understood that data indicated in this way can be interchanged under appropriate circumstances so that the embodiments of the disclosure described herein can be implemented in an order other than those illustrated or described herein. The implementation manners described in the following embodiments do not represent all implementation manners consistent with the disclosure. Rather, they are merely examples of devices and methods consistent with some aspects of the disclosure as detailed in the appended claims.

The disclosure may display a recording control on a playing interface in response to a video played on the playing interface being a first type, in which the recording control is for recording a user audio based a target song played in the video; display a recording interface in response to the recording control being triggered; record a user audio on the recording interface based on the target song; and generate a vocal file based on the user audio and the target song. That is, a video displaying interface (i.e., a displaying interface) is playing a video. The video may include frames and audio(s) of a song, and the corresponding target song or the segment of the corresponding target song may also be played when the video is played. The recording control for the target song may be displayed on the displaying interface in response to the video being the first type (i.e., the preset singing type). When a user triggers the recording control, the recording interface for this target song may be displayed. The user audio may be recorded based on the target song. The vocal file of the user may be generated by synthesizing based on the recorded user audio and the target song, such as a certain audio of the target song. The vocal file also refers to the singing work or the singing work file in embodiments of the disclosure. Therefore, the user may enter directly the recording interface from the playing interface. In some embodiments, the above-mentioned method may simplify the path of generating the vocal file, reduce operations, and save time and cost.

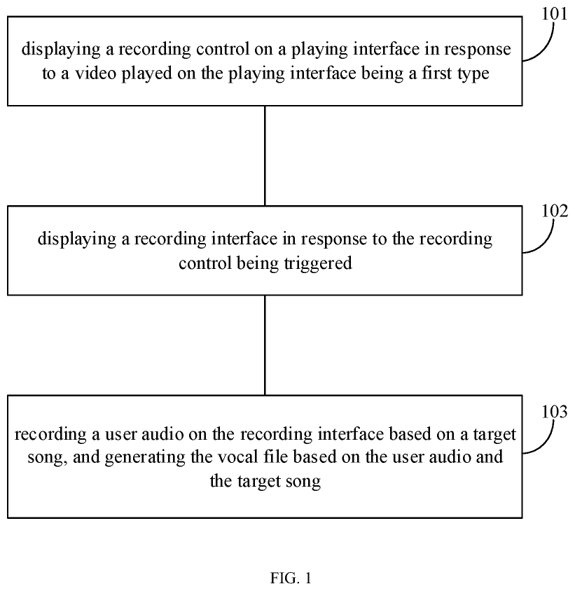

FIG. 1 is a flowchart illustrating a method for generating a vocal file according to some embodiments of the disclosure. The method is applicable to an electronic device. As illustrated in FIG. 1, the method may include the following.

At block 101, the electronic device can display a recording control on a playing interface in response to a video played on the playing interface being a first type. That is, the electronic device can detect the type of the video played currently on the video playing interface; when it is detected that the video is the first type (i.e., when it is detected that the video is the preset singing type), the electronic device can display the recording control for a target song played in the video, in which the target song played in the video may refer to the target song for short.

It should be noted that an execution subject of the method for generating the vocal file according to embodiments of the disclosure is an apparatus for generating a vocal file according to embodiments of the disclosure. The apparatus may be configured in the electronic device, to simplify the path of generating the vocal file, reduce operations, and save user's time and cost.

The electronic device may be any stationary or mobile computing device with a screen and a microphone. The computing device can process data. The mobile computing device may be such as a notebook computer, a smart phone, and a wearable device. The stationary computing device may be such as a desktop computer or any of other types of computing device. The apparatus may be an application program installed in the electronic device, such as Karaoke software, or a web page or application program for managing and maintaining Karaoke software by managers and developers, which is not limited in embodiments of the disclosure.

The singing type (i.e., the first type) may be a solo type or a chorus type, which is not limited in embodiments of the disclosure.

It is understandable that: taking Karaoke software as an example, the user may record his/her audio and/or his/her video on the recording interface of a certain song, thereby synthesizing his/her audio and/or his/her' video with an accompaniment audio of this song to generate the solo vocal file of the user. Or, the user may record his/her audio and/or his/her video on the recording interface of a certain song, thereby synthesizing his/her audio and/or his/her' video with an accompaniment audio of the song, and an original audio of the song to generate a chorus vocal file of the user.

That is, there is usually an audio of one person in the video with the solo type; and there are usually audios of two or more persons in the video with the chorus type.

Voiceprint features may vary with persons. Therefore, technologies such as voiceprint recognition may be utilized to recognize that the video includes how many types of voiceprint features, to determine that the video includes how many audios of several persons based on recognition results, and to determine the type of the video based on determination results, in embodiments of the disclosure. If an audio of one person is included in the video, it may determine that the type of the video is the solo type. If audios of two or more persons are included in the video, it may determine that the type of the video is the chorus type.

In some embodiments, the video with the solo type includes a user audio, and the video with the chorus type includes a user audio and an original audio. Therefore, the voiceprint recognition technology may be utilized to recognize whether the video includes the voiceprint feature of the original singer in embodiments of the disclosure. If the voiceprint feature of the original singer can be recognized from the video, the type of the video may be the chorus type. If the voiceprint feature of the original singer cannot be recognized from the video, the type of the video may be the solo type.

The target song in the video is the song corresponding to the audio in the video. For example, if the audio in the video is a segment of song A, the target song in the video is song A. Also, if the audio in the video is song A, the target song in the video is song A. In implementations, an audio database can be set in advance. The audio database includes a variety of audios and corresponding lyrics, names and other information. Therefore, the audio in the video may be extracted, and the target song in the video may be determined by comparing the extracted audio with each audio in the audio database. Alternatively, the audio in the video may be extracted, and the target song in the video may be determined by searching the Internet for an audio that matches the extracted audio.

In detail, when it is detected that the video played currently on the video playing interface is the preset singing type, the recording control for the target song in the video is displayed.

The recording control may include one or more controls. The recording control may be a button control, or other type of control, which is not limited in embodiments of the disclosure. Take the button control as an example in embodiments of the disclosure for describing.

The displaying position of the recording control may be set arbitrarily as required. For example, the recording control may be set on the lower right corner or the upper right corner of the playing interface, which is not limited in embodiments of the disclosure. The displaying style of the recording control may be also set arbitrarily as required. For example, the recording control may be displayed as a round icon with a yellow background, a square icon with a red background, an icon marked with “I want to sing”, or other icon, which is not limited in embodiments of the disclosure.

In implementations, the displaying styles vary with the types. When the video is detected as the solo type, the recording control may be displayed as an icon marked with the word “solo”, the font color of “solo” is red, and the background color of the icon is white. When the video is detected as the chorus type, the recording control may be displayed as an icon marked with the word “chorus”, the font color of “chorus” is black, and the background color of the icon is white.

It should be noted that the recording control may be displayed in a preset transparency. For example, the recording control may be displayed on the displaying interface semi-transparently, so that the recording control may be clearly displayed without blocking the displaying of the video.

At block 102, the electronic device can display a recording interface in response to the recording control being triggered. That is, the electronic device can display the recording interface of the target song in response to a triggering operation of the user on the recording control.

At block 103, the electronic device can record a user audio on the recording interface based on a target song, and generate the vocal file based on the user audio and the target song. That is, the user audio is recorded on the recording interface based on the audio of the target song, and the vocal file of the user is generating by synthesizing corresponding audios accordingly.

The audio of the target song may include the original audio and the accompaniment audio.

It is understandable that when the user wants to record his/her singing work (i.e., his/her singing file) about the target song in the video played on the video playing interface, he/she may trigger the recording control by clicking, double-clicking, sliding, or long pressing. Therefore, the apparatus for generating the vocal file may respond to the triggering operation of the user on the recording control, and display the recording interface of the song.

In some embodiments, controls with various functions may be displayed on the recording interface of the target song as required. For example, the recording interface of the target song may display the recording control with the function of starting the recording or pausing the recording, so that it may start recording the user audio based on the audio of the target song or pause recording the user audio based on the audio of the target song in response to the triggering operation of the user on the recording control. In addition, the recording interface of the target song may display the lyrics of the song, so that the user may sing the target song based on the displayed lyrics. In addition, the recording interface of the target song may display an adjustment control of adjusting the volume of the audio, so that the volume of the audio of the target song may be adjusted in response to the triggering operation of the user on the adjustment control. In addition, the recording interface of the target song may display a switch control with the function of turning on or off the original audio, so that the original audio may be turned on or off when recording the user audio in response to the triggering operation of the user on the switch control.

Each of the above-mentioned controls may be the button control, or any of other types of controls, which is not limited in embodiments of the disclosure. The embodiments of the disclosure are described by taking the foregoing controls as button controls as an example.

It should be noted that when the lyrics of the target song are displayed on the recording interface of the song, the displaying form of the lyrics may be arbitrarily set as needed. For example, the number of lines of displaying the lyrics is preset to 3 lines, in which the first line shows the lyrics corresponding to the audio currently being recorded, the lyrics on the first line may be highlighted or in a form of font enlargement, and the second line and the third line show the lyrics following the lyrics shown in the first line. Therefore, the lyrics of the target song may be scrolled and displayed in synchronization with the audio of the target song based on the timeline of the song. In some embodiments, by displaying part of the lyrics on the recording interface of the song, the above-mentioned method may reduce the space occupied by the region where the lyrics are located on the recording interface of the target song, and provide more space for the full display of other information on the recording interface.

In implementations, the user may sing a target song based on the audio of the target song on the recording interface, so that the apparatus for generating the vocal file may record the user audio. After the user audio is recorded on the recording interface based on the target song, the user audio may be synthesized with the accompaniment audio of the target song to generate the solo singing work (i.e., the solo vocal file) of the user. Or, the user audio may be synthesized with the accompaniment audio of the target song and the original audio of the target song to generate the chorus singing work (i.e., the chorus vocal file) of the user.

The method in embodiments of the disclosure will be described in combination with examples, which takes the type including the solo type or the chorus type as examples.

It should be noted that the playing interface and the recording interface illustrated in the drawings of the various embodiments of the disclosure are exemplary, and cannot be used as a limitation to the technical solutions of the embodiments of the disclosure. The displaying mode of the playing interface and the recording interface may be arbitrarily set based on needs by these skilled in the art, which is not limited in the embodiments of the disclosure. Moreover, the controls on the playing interface and the recording interface, illustrated in the drawings of the various embodiments of the disclosure, are part of controls on the playing interface and the recording interface. In applications, other controls may also be displayed as needed. For example, the playing interface may display a sharing control, and a control that may like or comment on the video in response to a corresponding triggering operation of the user, which is not limited in embodiments of the disclosure.

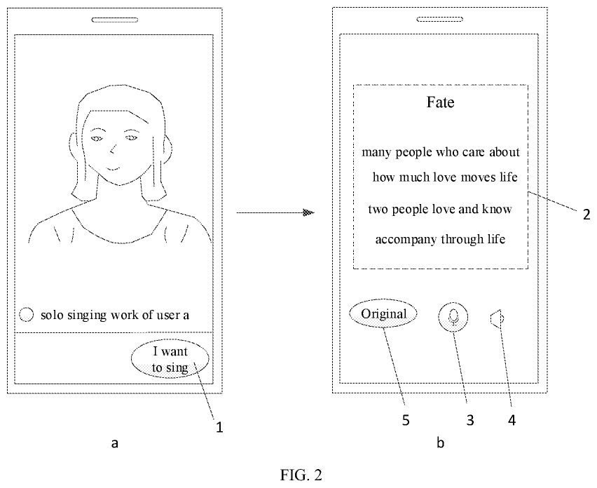

As illustrated in FIG. 2, the solo video of user a is being played on the video playing interface. When it is detected that the video played on the playing interface is the solo type, and the target song in the video is “Fate”, the recording control for “Fate” may be displayed at the lower right corner of the playing interface, i.e., the control 1 illustrated in FIG. 2(a).

The recording interface of the target song “Fate” may be displayed as illustrated in FIG. 2(b) in response to the triggering operation of the user on the control 1. The recording interface of the target song “Fate” may display the name and lyrics of the target song “Fate” on the region illustrated by the dotted box 2 in FIG. 2(b), so that the user may complete the singing of the target song based on the displayed lyrics. The recording control of starting or pausing the recording may be illustrated at the bottom of the recording interface, i.e., the control 3 in FIG. 2(b), so that it may start recording the user audio based on the audio of the target song or pausing recording the user audio based on the audio of the target song in response to the triggering operation of the user on the control 3. The adjustment control with the function of adjusting the volume of the audio may also be displayed at the bottom of the recording interface, that is, the control 4 in FIG. 2(b), so that it may control the volume of the audio of the target song in response to the triggering operation of the user on the control 4. The recording interface also display a switch control with the function of turning on or off the original audio, that is, the control 5 in FIG. 2(b), so that it may turn on or off the original audio in response to the triggering operation of the user on the control 5 when the user audio is recorded.

After the user triggers the control 3, the user audio may be recorded on the recording interface based on the audio of the target song “Fate”, and the user audio and the audio of the target song “Fate” may be synthesized to generate the vocal file (or the singing work) of the user. Therefore, the user may directly enter the recording interface in FIG. 2(b) from the playing interface in FIG. 2(a) through the control 1 displayed on the playing interface, to record the user audio and further generate the vocal file of the user.

With the method for generating the vocal file provided in embodiments of the disclosure, when it is detected that the video currently played on the playing interface is the preset singing type, the recording control for the target song in the video may be displayed on the playing interface; the recording interface of the target song may be displayed in response to the triggering operation of the user on the recording control; the user audio may be recorded on the recording interface based on the audio of the song; and the vocal file of the user may be obtained by synthesizing the corresponding audios. Therefore, the user may enter the recording interface directly from the playing interface through the recording control, and the user audio may be recorded on the recording interface. Since the user does not need to repeatedly watch the video played in the playing interface to determine the name of the audio in the video, and then enter the search interface to input the search term to search for the song, and select the target song from the search results, and enter the recording interface of the target song for audio recording, it simplifies the path of generating the vocal file, reduces operations of the user, and saves the user's time and cost.

With the method for generating the vocal file provided in embodiments of the disclosure, the recording control may be displayed on the displaying interface in response to the video currently played on the displaying interface being the first type; the recording interface may be displayed in response to the recording control being triggered; the user audio may be recorded on the recording interface based on the audio of the target song in the video; and the vocal file is generated based on the user audio and the audio of the song. It may enter the recording interface of the target song from the playing interface directly through the recording control for the song, which simplifies the path of generating the vocal file, thereby reducing user operations and saving users' time and cost.

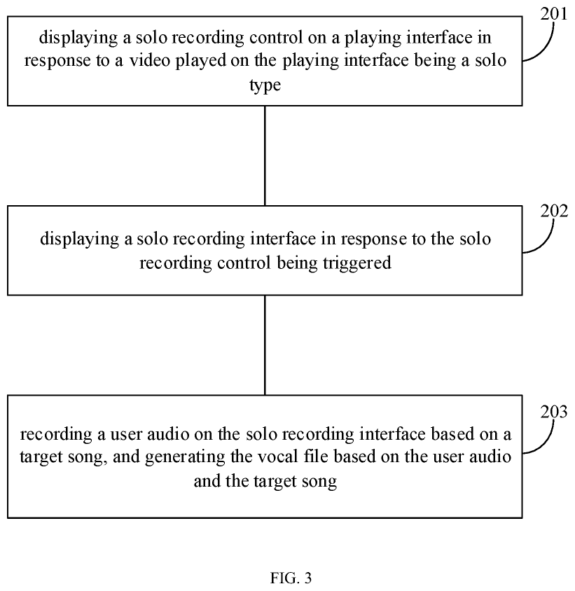

It is understandable that, when it is detected that the video currently played on the playing interface is the preset singing type, the recording control for the target song in the video may be displayed on the playing interface; the recording interface of the target song may be displayed in response to the triggering operation of the user on the recording control; the user audio may be recorded on the recording interface based on the audio of the song; and the vocal file of the user may be obtained by synthesizing the corresponding audios. The method for generating the vocal file provided in the embodiments of the disclosure may be described in conjunction with FIG. 3 and taking the video as the solo type as an example as follows.

FIG. 3 is a flowchart illustrating a method for generating a vocal file according to some embodiments of the disclosure. The method is applicable to an electronic device. The video is the solo type. As illustrated in FIG. 3, the method may include the following.

At block 201, the electronic device can display a solo recording control on a playing interface in response to a video played on the playing interface being the solo type. That is, the electronic device can detect the type of the video played currently on the video playing interface, and when it is detected that the video is the solo type, the electronic device can display the solo recording control for a target song in the video on a preset region of the playing interface.

The preset region may be located at any position of the playing interface. For example, it may be located at the top position, the bottom position, or the middle position of the playing interface, which is not limited in the embodiments of the disclosure.

In applications, the playing interface may also display other information such as a name and an avatar of the author of the video. The preset region may be set based on other information that has been displayed in the playing interface. For example, it may be set to be located on the right side of the name of the author of the video on the playing interface, or below the avatar of the author of the video on the playing interface.

The solo recording control allows the user to enter the solo recording interface of the target song by touching this control, so as to record the solo singing work.

The displaying style of the solo recording control may be set as needed. For example, the solo recording control may be displayed as a round icon with a yellow background, a square icon with a red background, an icon marked with “I want to sing” or “solo”, or other icon, which is not limited in embodiments of the disclosure.

The displaying size of the solo recording control may be set based on factors such as other information already displayed on the playing interface and the size of the screen. For example, when the size of the screen is larger, and the other information displayed on the playing interface is smaller, the displaying size of the solo recording control may be set to be larger. When the size of the screen is smaller, and the other information displayed on the playing interface is smaller, the displaying size of the solo recording control may be set to be smaller.

It is understandable that the video of the solo type usually includes the audio of one person. In embodiments of the disclosure, when it is detected that the audio of the video played on the interface includes the audio of one person, the type of the video may be determined to be the solo type, and the preset solo recording control may be displayed on the preset region of the playing interface.

In some embodiments, the video of the solo type includes the user audio, and the video of the chorus type includes the user audio and the original audio. Therefore, in embodiments of the disclosure, the voiceprint recognition technology cannot recognize the voiceprint feature of the original singer from the video, the type of the video may be determined to be the solo type. The preset solo recording control may be displayed on the preset region of the playing interface.

At block 202, the electronic device can display a solo recording interface in response to the solo recording control being triggered. That is, the electronic device can display the solo recording interface of the target song in response to a triggering operation of the user on the solo recording control.

At block 203, the electronic device can record a user audio on the solo recording interface based on the target song, and generate the vocal file based on the user audio and the target song. That is, the user audio is recorded on the solo recording interface based on the audio of the song, and the solo vocal file of the user is generating by synthesizing corresponding audios accordingly.

The audio of the target song may include the original audio and the accompaniment audio.

It is understandable that when the user wants to record his/her solo singing work (i.e., his/her solo singing file) about the target song in the video played on the playing interface, he/she may trigger the solo recording control by clicking, double-clicking, sliding, or long pressing. Therefore, the apparatus for generating the vocal file may respond to the triggering operation of the user on the solo recording control, and display the solo recording interface of the song.

In some embodiments, controls with various functions may be displayed on the solo recording interface of the target song as required. For example, the solo recording interface may display a switch control for switching between the solo recording interface and the chorus recording interface, so that it may switch between the solo recording interface and the chorus recording interface in response to the triggering operation of the user on the switch control. In addition, the displaying styles of the switch control may be different in different interfaces. For example, it may be displayed as an icon containing a microphone mark on the solo recording interface, and it may be displayed as an icon containing two microphone marks on the chorus recording interface, so that the user may understand that the solo singing work is currently being recorded through the displaying style of the switch control on the solo recording interface. In addition, the solo recording interface may display the recording control with the function of starting the recording or pausing the recording, so that it may start recording the user audio based on the audio of the target song or pause recording the user audio based on the audio of the target song in response to the triggering operation of the user on the recording control. In addition, the solo recording interface may display the lyrics of the song, so that the user may sing the target song based on the displayed lyrics. In addition, the solo recording interface may display an adjustment control of adjusting the volume of the audio, so that the volume of the audio of the target song may be adjusted in response to the triggering operation of the user on the adjustment control. In addition, the solo recording interface may display a switch control with the function of turning on or off the original audio, so that the original audio may be turned on or off when recording the user audio in response to the triggering operation of the user on the switch control.

In implementations, after the user audio is recorded on the solo recording interface based on the audio of the song, the user audio and the accompaniment audio of the target song may be synthesized to generate the solo singing work of the user.

In embodiments, the solo singing work of the user may be an audio-type singing work including audio or a video-type singing work including audio and video. Correspondingly, in order to record different types of solo singing works, an audio-type recording control or a video-type recording control may be displayed on the solo recording interface. Therefore, when the user triggers the audio-type recording control by clicking, double-clicking, sliding, long pressing, etc., it may respond to the triggering operation of the user on the audio-type recording control, and record the user audio based on the audio of the target song on the solo recording interface. The user audio and the accompaniment audio of the target song may be synthesized to generate the audio type of solo singing work. When the user triggers the video-type recording control by clicking, double-clicking, sliding, long pressing, etc., it may respond to the triggering operation of the user on the video-type recording control, and record the user audio and the video of the user on the solo recording interface. The user audio, the video of the user, and the accompaniment audio of the target song may be synthesized to generate the video type of solo singing work.

In the following, under a case that the video is the solo type, the method for generating the vocal file in embodiments of the disclosure will be described in conjunction with examples.

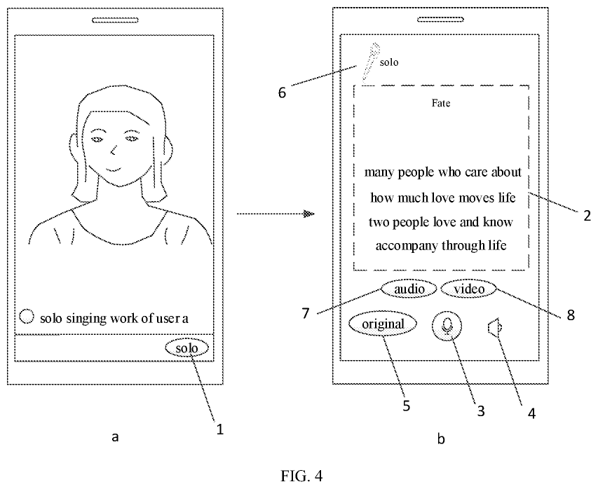

As illustrated in FIG. 4, the solo video of user a is being played on the video playing interface. When it is detected that the video played on the playing interface is the solo type, and the target song in the video is “Fate”, the solo recording control for “Fate” may be displayed at the lower right corner of the playing interface, i.e., the control 1 illustrated in FIG. 4(a). Therefore, the user may enter the solo recording interface of the target song “Fate” by touching this control, so as to record the solo singing work on the solo recording interface.

The solo recording interface of the target song “Fate” may be displayed as illustrated in FIG. 4(b) in response to the triggering operation of the user on the control 1. The solo recording interface of the target song “Fate” may display the switch control for indicating the current recording being recording the solo singing work, i.e., the control 6 illustrated in FIG. 4(b). The user may learn that the solo singing work is currently being recorded through the control 6. The solo recording interface may display the audio-type recording control, i.e., the control 7 in FIG. 4(b). The solo recording interface may display the video-type recording control, i.e., the control 8 in FIG. 4(b). Therefore, the user may trigger the control 7 or the control 8 to select to record the solo singing work of audio type or the solo singing work of video type. In addition, the name and lyrics of the target song “Fate” may be displayed at the region illustrated by the dotted box 2 in FIG. 4(b), so that the user may complete the singing of the target song based on the displayed lyrics. The recording control of starting or pausing the recording may be illustrated at the bottom of the solo recording interface, i.e., the control 3 in FIG. 4(b), so that it may start recording the user audio based on the audio of the target song or pausing recording the user audio based on the audio of the target song in response to the triggering operation of the user on the control 3. The adjustment control with the function of adjusting the volume of the audio may also be displayed at the bottom of the solo recording interface, that is, the control 4 in FIG. 4(b), so that it may control the volume of the audio of the target song in response to the triggering operation of the user on the control 4. The solo recording interface also display a switch control with the function of turning on or off the original audio, that is, the control 5 in FIG. 4(b), so that it may turn on or off the original audio in response to the triggering operation of the user on the control 5 when the user audio is recorded.

After the user triggers the control 3 in FIG. 4(b), closes the original audio by triggering the control 5, and triggers the control 7, the original audio may be closed on the solo recording interface, while the user audio may be recorded based on the audio of the target song “Fate”. The user audio may be synthesized with the accompaniment audio of the target song “Fate” to generate the solo singing work of the user.

Therefore, the user may directly enter the solo recording interface of the target song “Fate” from the playing interface by triggering the solo recording control displayed on the playing interface to record the user audio, so as to generate the solo singing work of the user.

With the method for generating the vocal file provided in embodiments of the disclosure, when it is detected that the video currently played on the playing interface is the solo type, the preset solo recording control may be displayed at the preset region on the playing interface; the solo recording interface of the target song may be displayed in response to the triggering operation of the user on the solo recording control; the user audio may be recorded on the solo recording interface based on the audio of the song; and the solo vocal file of the user may be obtained by synthesizing the corresponding audios. Therefore, the user may enter the solo recording interface directly from the playing interface through the solo recording control, and the user audio may be recorded on the solo recording interface. Since the user does not need to repeatedly watch the video played in the video playing interface to determine the name of the audio in the video, and then enter the search interface to input the search term to search for the song, and select the target song from the search results, and enter the recording interface of the target song for audio recording, it simplifies the path of generating the solo vocal file, reduces operations of the user, and saves the user's time and cost.

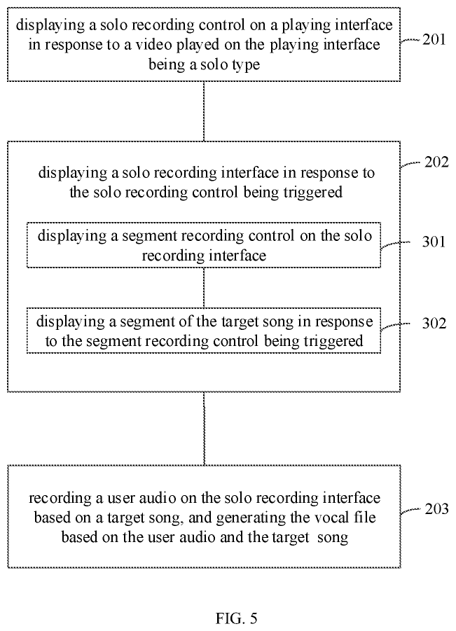

It is understandable that, in applications, the user needs to obtain his/her vocal file about a popular segment of the song. If the user audio is recorded based on the audio of the entire song, and the singing work of the user on the entire target song is generated, it needs a cropping operation on the singing work of the user on the entire target song in the later stage, so as to generate the singing work that includes the audio about the popular segment of the song. In embodiments of the disclosure, in order to reduce the post-processing such as the cropping operation when generating the singing work that includes the audio about the popular segment, a segment recording control is displayed on the recording interface of the song, so that the user may directly record the singing work including the audio about the popular segment of the target song through the segment recording control. In view of the above situation, the method for generating the singing work provided in embodiments of the disclosure will be further described below in conjunction with FIG. 5.

FIG. 5 is a flowchart illustrating a method for generating a vocal file according to some embodiments of the disclosure. The method is applicable to an electronic device. The action at block 202 may include the following as illustrated in FIG. 5. Also, it should understand that the following action may also applicable to a case that the vide is the chorus type.

At block 301, the electronic device can display a segment recording control on the solo recording interface. That is, the segment recording control for recording the popular segment of the target song is displayed on the solo recording interface.

The segment recording control may be a button control or any of other types of controls, which is not limited in embodiments of the disclosure. The embodiments of the disclosure may be described by taking the segment recording control as the button control as an example.

The displaying position of the segment recording control may be set arbitrarily as required. For example, the segment recording control may be set on the lower right corner or the lower left corner of the solo recording interface, which is not limited in embodiments of the disclosure. The displaying style of the segment recording control may be also set arbitrarily as required. For example, the segment recording control may be displayed as a round icon with a yellow background, a square icon with a red background, an icon marked with “segment”, or other icon, which is not limited in embodiments of the disclosure.

At block 302, the electronic device can display a segment of the target song in response to the segment recording control being triggered. That is, a popular segment of the target song is displayed in response to the triggering operation of the user on the segment recording control.

It is understandable that when the user wants to record his/her singing work (i.e., his/her vocal file) about the popular segment of the song, he/she may trigger the segment recording control by clicking, double-clicking, sliding, or long pressing. Therefore, the apparatus for generating the vocal file may respond to the triggering operation of the user on the segment recording control, and display the popular segment of the song. Thus, the user audio, corresponding to the popular segment, may be recorded based on the popular segment of the song. The user audio, corresponding to the popular segment, may be synthesized with the accompaniment audio corresponding to the popular segment, to generate the solo singing work including the audio of the popular segment.

The displaying position of the segment of the target song may be set arbitrarily at any position of the solo recording interface as required. For example, the segment of the target song may be set on the lower right corner or the upper right corner of the solo recording interface, which is not limited in embodiments of the disclosure.

The displaying style of the segment of the target song may be also set arbitrarily as required. For example, the number of lines of displaying the segment of the target song is preset to 3 lines, in which the first line shows the lyrics corresponding to the audio currently being recorded, the lyrics on the first line may be highlighted or in a form of font enlargement, and the second line and the third line show the lyrics following the lyrics shown in the first line. Therefore, the segment of the target song may be scrolled and displayed in synchronization with the audio of the target song based on the timeline of the song.

The method for generating the vocal file in embodiments of the disclosure will be described in combination with examples under a case that the singing type is the solo type.

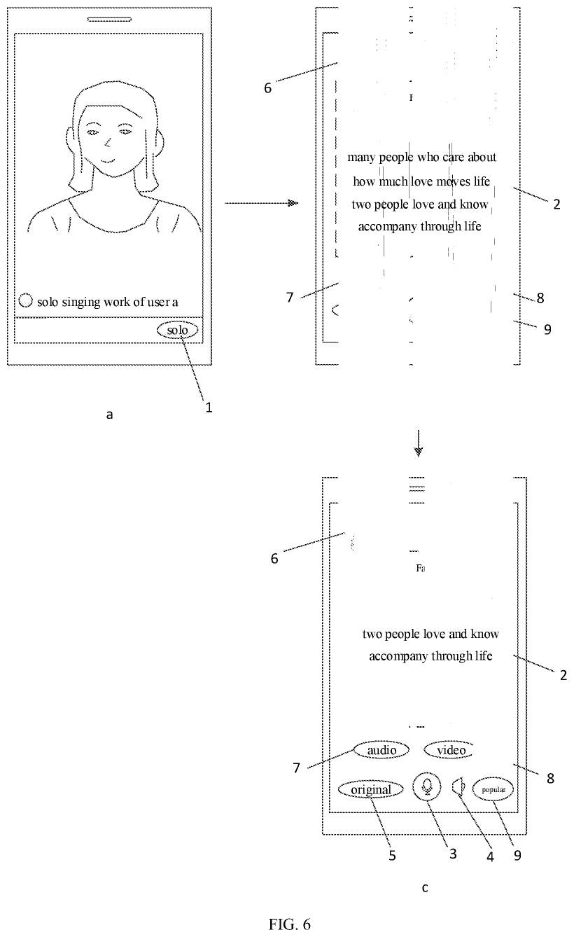

As illustrated in FIG. 6, the solo video of user a is being played on the video playing interface. When it is detected that the video played on the playing interface is the solo type, and the target song in the video is “Fate”, the solo recording control for “Fate” may be displayed at the lower right corner of the playing interface, i.e., the control 1 illustrated in FIG. 6(a). Therefore, the user may enter the solo recording interface of the target song “Fate” by touching this control, so as to record the solo singing work on the solo recording interface.

The solo recording interface of the target song “Fate” may be displayed as illustrated in FIG. 6(b) in response to the triggering operation of the user on the control 1. The solo recording interface of the target song “Fate” may display the switch control for indicating the current recording being recording the solo singing work, i.e., the control 6 illustrated in FIG. 6(b). The user may learn that the solo singing work is currently being recorded through the control 6. The solo recording interface may display the audio-type recording control, i.e., the control 7 in FIG. 6(b). The solo recording interface may display the video-type recording control, i.e., the control 8 in FIG. 6(b). Therefore, the user may trigger the control 7 or the control 8 to select to record the solo singing work of audio type or the solo singing work of video type. In addition, the name and lyrics of the target song “Fate” may be displayed at the region illustrated by the dotted box 2 in FIG. 6(b), so that the user may complete the singing of the target song based on the displayed lyrics. The recording control of starting or pausing the recording may be illustrated at the bottom of the solo recording interface, i.e., the control 3 in FIG. 6(b), so that it may start recording the user audio based on the audio of the target song or pausing recording the user audio based on the audio of the target song in response to the triggering operation of the user on the control 3. The solo recording interface may display the segment recording control, that is, the control 9 in FIG. 6(b), so that the segment of the song, corresponding to the popular segment, may be displayed in response to the triggering operation of the user on the control 9. The adjustment control with the function of adjusting the volume of the audio may also be displayed at the bottom of the solo recording interface, that is, the control 4 in FIG. 6(b), so that it may control the volume of the audio of the target song in response to the triggering operation of the user on the control 4. The solo recording interface also display a switch control with the function of turning on or off the original audio, that is, the control 5 in FIG. 6(b), so that it may turn on or off the original audio in response to the triggering operation of the user on the control 5 when the user audio is recorded.

Assuming that the popular segment of the target song “Fate” is “two people love and know, accompany through life . . . ” After the user triggers the control 9, it may respond to the triggering operation of the user on the control 9, such the segment of the target song corresponding to the popular segment may be displayed at the region 2 on the solo recording interface.

After the user triggers the control 3 in FIG. 6(b), closes the original audio by triggering the control 5, and triggers the control 7, the original audio may be closed on the solo recording interface, while the user audio may be recorded based on the segment of the target song corresponding to the popular segment of the target song “Fate”. The user audio may be synthesized with the accompaniment audio of the segment of the target song to generate the solo singing work of the user.

Therefore, the user may enter the solo recording interface of the “Fate” from the playing interface by triggering the solo recording control displayed on the playing interface to perform recording to generate the solo singing work of the user. By displaying the segment recording controls on the solo recording interface, the user may directly record the popular segment, reducing the post-processing such as cropping and other operations on the singing work on the entire song, reducing the operations and saving user's time and cost.

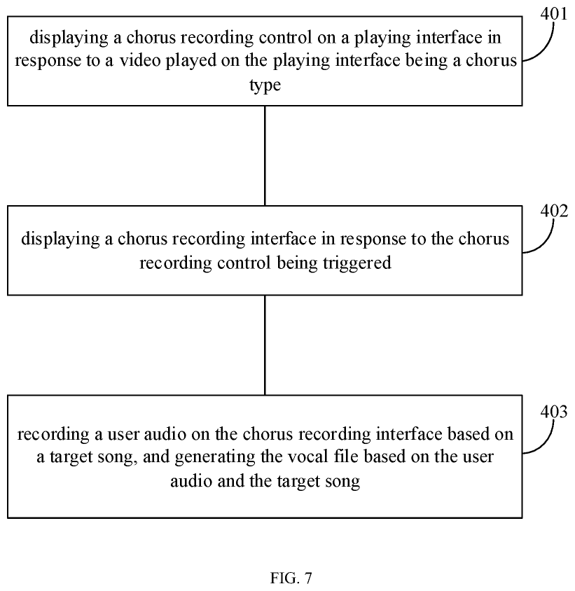

The foregoing embodiments take the video of the solo type as an example to illustrate the method for generating the vocal file provided in embodiments of the disclosure. In the following, with reference to FIG. 7, taking the video of the chorus type as an example, the method for generating the vocal file provided in embodiments of the disclosure will be described.

FIG. 7 is a flowchart illustrating a method for generating a vocal file according to some embodiments of the disclosure. The method is applicable to an electronic device. The video is the chorus type. As illustrated in FIG. 7, the method may include the following.

At block 401, the electronic device can display a chorus recording control on a playing interface in response to a video played on the playing interface being the chorus type. That is, the electronic device can detect the type of the video played currently on the video playing interface; and when it is detected that the video is the chorus type, the electronic device can display the chorus recording control for a target song in the video on a preset region of the playing interface.

The preset region may be located at any position of the playing interface. For example, it may be located at the top position, the bottom position, or the middle position of the playing interface, which is not limited in the embodiments of the disclosure.

In applications, the playing interface may also display other information such as a name and an avatar of the author of the video. The preset region may be set based on other information that has been displayed in the playing interface. For example, it may be set to be located on the right side of the name of the author of the video on the playing interface, or below the avatar of the author of the video on the playing interface.

The chorus recording control allows the user to enter the chorus recording interface of the target song by touching this control, so as to record the chorus singing work.

The displaying style of the chorus recording control may be set as needed. For example, the chorus recording control may be displayed as a round icon with a gray background, an oval icon with a red background, an icon marked with “I want to sing” or “chorus”, or other icon, which is not limited in embodiments of the disclosure.

The displaying size of the chorus recording control may be set based on factors such as other information already displayed on the playing interface and the size of the screen. For example, when the size of the screen is larger, and the other information displayed on the playing interface is smaller, the displaying size of the chorus recording control may be set to be larger. When the size of the screen is smaller, and the other information displayed on the playing interface is smaller, the displaying size of the chorus recording control may be set to be smaller.

It is understandable that the video of the chorus type usually includes the audios of two or more persons. In embodiments of the disclosure, when it is detected that the audio of the video played on the interface includes the audios of two or more persons, the type of the video may be determined to be the chorus type, and the preset chorus recording control may be displayed on the preset region of the playing interface.

In some embodiments, the video of the solo type includes the user audio, and the video of the chorus type includes the user audio and the original audio. Therefore, in embodiments of the disclosure, the voiceprint recognition technology can recognize the voiceprint feature of the original singer from the video, the type of the video may be determined to be the chorus type. The preset chorus recording control may be displayed on the preset region of the playing interface.

At block 402, the electronic device can display a chorus recording interface in response to the chorus recording control being triggered. That is, the chorus recording interface of the target song (or the song) is displayed in response to a triggering operation of the user on the chorus recording control.

At block 403, the electronic device can record a user audio on the chorus recording interface based on an audio of the song, and generate the vocal file based on the user audio and the target song. That is, the user audio is recorded on the chorus recording interface based on the audio of the target song, and the vocal file of the user is generating by synthesizing corresponding audios accordingly.

The audio of the target song may include the original audio and the accompaniment audio.

It is understandable that when the user wants to record his/her chorus singing work (i.e., his/her chorus vocal file) about the target song in the video played on the playing interface, he/she may trigger the chorus recording control by clicking, double-clicking, sliding, or long pressing. Therefore, the apparatus for generating the vocal file may respond to the triggering operation of the user on the chorus recording control, and display the chorus recording interface of the song.

In some embodiments, controls with various functions may be displayed on the chorus recording interface of the target song as required. For example, the chorus recording interface may display a switch control for switching between the solo recording interface and the chorus recording interface, so that it may switch between the solo recording interface and the chorus recording interface in response to the triggering operation of the user on the switch control. In addition, the displaying styles of the switch control may be different in different interfaces. For example, it may be displayed as an icon containing a microphone mark on the solo recording interface, and it may be displayed as an icon containing two microphone marks on the chorus recording interface, so that the user may understand that the chorus singing work is currently being recorded through the displaying style of the switch control on the chorus recording interface. In addition, the chorus recording interface may display the recording control with the function of starting the recording or pausing the recording, so that it may start recording the user audio based on the audio of the target song or pause recording the user audio based on the audio of the target song in response to the triggering operation of the user on the recording control. In addition, the chorus recording interface may display the lyrics of the song, so that the user may sing the target song based on the displayed lyrics. In addition, the chorus recording interface may display an adjustment control of adjusting the volume of the audio, so that the volume of the audio of the target song may be adjusted in response to the triggering operation of the user on the adjustment control. In addition, the chorus recording interface may display a switch control with the function of turning on or off the original audio, so that the original audio may be turned on or off when recording the user audio in response to the triggering operation of the user on the switch control.

In implementations, after the user audio is recorded on the chorus recording interface based on the audio of the song, the user audio, the accompaniment audio of the song, and the original audio of the target song may be synthesized to generate the chorus singing work of the user.

In embodiments, the chorus singing work of the user may be an audio-type singing work including audio or a video-type singing work including audio and video. Correspondingly, in order to record different types of chorus singing works, an audio-type recording control or a video-type recording control may be displayed on the chorus recording interface. Therefore, when the user triggers the audio-type recording control by clicking, double-clicking, sliding, long pressing, etc., it may respond to the triggering operation of the user on the audio-type recording control, and record the user audio based on the audio of the target song on the chorus recording interface. The user audio, the accompaniment audio of the song, and the original audio may be synthesized to generate the audio type of chorus singing work. When the user triggers the video-type recording control by clicking, double-clicking, sliding, long pressing, etc., it may respond to the triggering operation of the user on the video-type recording control, and record the user audio and the video of the user on the chorus recording interface. The user audio, the video of the user, the accompaniment audio of the song, and the original audio may be synthesized to generate the video type of chorus singing work.

It should be noted that when the video is the chorus type, the segment recording control for the target song may also be displayed on the chorus recording interface, so as to respond to the triggering operation of the user on the segment recording control, display the segment of the target song corresponding to the popular segment.

In the following, under a case that the video is the chorus type, the method for generating the vocal file in embodiments of the disclosure will be described in conjunction with examples.

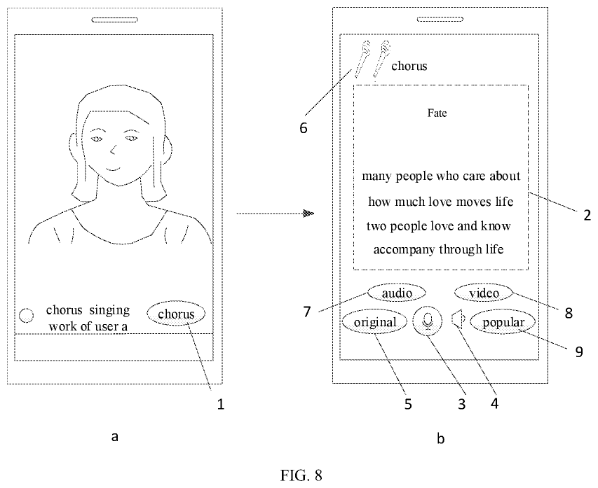

As illustrated in FIG. 8, the chorus video of user a is being played on the video playing interface. When it is detected that the video played on the playing interface is the chorus type, and the target song in the video is “Fate”, the chorus recording control for “Fate” may be displayed at the lower right corner of the playing interface, i.e., the control 1 illustrated in FIG. 8(a). Therefore, the user may enter the chorus recording interface of the target song “Fate” by touching this control, so as to record the chorus singing work on the chorus recording interface.

The chorus recording interface of the target song “Fate” may be displayed as illustrated in FIG. 8(b) in response to the triggering operation of the user on the control 1. The chorus recording interface of the target song “Fate” may display the switch control for indicating the current recording being recording the chorus singing work, i.e., the control 6 illustrated in FIG. 8(b). The user may learn that the chorus singing work is currently being recorded through the control 6. The chorus recording interface may display the audio-type recording control, i.e., the control 7 in FIG. 8(b). The chorus recording interface may display the video-type recording control, i.e., the control 8 in FIG. 8(b). Therefore, the user may trigger the control 7 or the control 8 to select to record the chorus singing work of audio type or the chorus singing work of video type. In addition, the name and lyrics of the target song “Fate” may be displayed at the region illustrated by the dotted box 2 in FIG. 8(b), so that the user may complete the singing of the target song based on the displayed lyrics. The recording control of starting or pausing the recording may be illustrated at the bottom of the chorus recording interface, i.e., the control 3 in FIG. 8(b), so that it may start recording the user audio based on the audio of the target song or pausing recording the user audio based on the audio of the target song in response to the triggering operation of the user on the control 3. The chorus recording interface may display the segment recording control, that is, the control 9 in FIG. 8(b), so that the segment of the song, corresponding to the popular segment, may be displayed in response to the triggering operation of the user on the control 9. The adjustment control with the function of adjusting the volume of the audio may also be displayed at the bottom of the chorus recording interface, that is, the control 4 in FIG. 8(b), so that it may control the volume of the audio of the target song in response to the triggering operation of the user on the control 4. The chorus recording interface also display a switch control with the function of turning on or off the original audio, that is, the control 5 in FIG. 8(b), so that it may turn on or off the original audio in response to the triggering operation of the user on the control 5 when the user audio is recorded.

After the user triggers the control 3, closes the original audio by triggering the control 5, and triggers the control 7, the original audio may be closed on the chorus recording interface, while the user audio may be recorded based on the audio of the target song “Fate”. The user audio may be synthesized with the accompaniment audio of the target song “Fate”, and the original audio to generate the chorus singing work of the user.

Therefore, the user may directly enter the chorus recording interface of the target song “Fate” from the playing interface by triggering the chorus recording control displayed on the playing interface to record the user audio, so as to generate the chorus singing work of the user.

With the method for generating the vocal file provided in embodiments of the disclosure, when it is detected that the video currently played on the playing interface is the chorus type, the preset chorus recording control may be displayed at the preset region on the playing interface; the chorus recording interface of the target song may be displayed in response to the triggering operation of the user on the chorus recording control; the user audio may be recorded on the chorus recording interface based on the audio of the song; and the chorus vocal file of the user may be obtained by synthesizing corresponding audios. Therefore, the user may enter the chorus recording interface directly from the playing interface through the chorus recording control, and the user audio may be recorded on the chorus recording interface. Since the user does not need to repeatedly watch the video played in the video playing interface to determine the name of the audio in the video, and then enter the search interface to input the search term to search for the song, and select the target song from the search results, and enter the recording interface of the target song for audio recording, the method simplifies the path of generating the chorus vocal file, reduces operations of the user, and saves the user's time and cost.

The above analysis shows that when the video is the chorus type, the user audio may be recorded on the chorus recording interface. The vocal file may be generated by synthesizing the user audio with the accompaniment audio and the original audio. The process of recording the user audio based on the audio of the target song on the recording interface and generating the vocal file of the user will be described in the following.

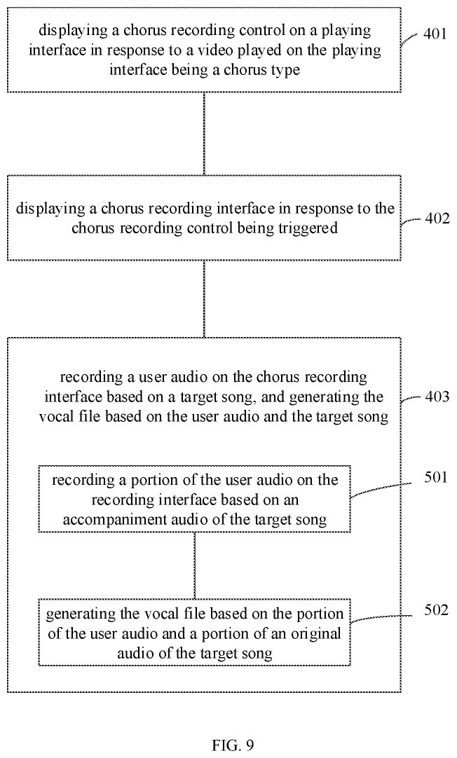

FIG. 9 is a flowchart illustrating a method for generating a vocal file according to some embodiments of the disclosure. The method is applicable to an electronic device. The video is a chorus type. The action at block 403 as illustrated in FIG. 7 may include the following, as illustrated in FIG. 9.

At block 501, the electronic device can record a portion of the user audio on the recording interface based on an accompaniment audio of the target song.

At block 502, the electronic device can generate the vocal file based on the portion of the user audio and a portion of an original audio of the target song.

In detail, when the singing audio (or the audio) of the user is recorded, the lyrics that need to be sung by the user may be displayed on the recording interface based on the accompaniment audio of the song, so that a portion of the user audio may be recorded while the user is singing, and the recorded portion of the user audio may be synthesized with the portion of the original audio (which is corresponding to the lyrics that the user has not sung), to generate the chorus singing work of the user.

In embodiments, the lyrics that require the user to sing may be distinguished from the lyrics that do not require the user to sing through a variety of methods. For example, it may mark whether the user needs to sing at the beginning of each sentence of the lyrics, such as it marks “user” at the beginning of each sentence that need the user to sing, and it marks “original” at the beginning of each sentence that do not need the user to sing. Or, the lyrics that require the user to sing and the lyrics that do not require the user to sing are displayed in different colors. Or, the lyrics that need to be sung by the user may be displayed on the recording interface based on the accompaniment audio of the song, and the lyrics that do not require the user to sing are not displayed.

In some embodiments, the lyrics that require the user to sing may be preset by the apparatus for generating the vocal file, or by the user, which is not limited in the embodiments of the disclosure. For example, the apparatus for generating the vocal file may preset the user to randomly sing part of the lyrics of the song, or sing one sentence every other sentence, or sing part of the lyrics of the target song based on the gender of the user for male and female duet songs. For example, it is assumed that the target song includes 20 lyrics, and the first sentence, the

third sentence, the fifth sentence, the seventh sentence, the ninth sentence, the eleventh sentence, the thirteenth sentence, the fifteenth sentence, the seventeenth sentence and the nineteenth sentence of the 20 lyrics are set to require the user to sing. If the user audio is recorded, the first sentence of the lyrics is displayed on the recording interface when the accompaniment audio corresponds to the first sentence of the lyrics; the second sentence of the lyrics is not displayed on the recording interface when the accompaniment audio corresponds to the second sentence of the lyrics; the third sentence of the lyrics is displayed on the recording interface when the accompaniment audio corresponds to the third sentence of the lyrics, and so on, until the target song is recorded, so as to obtain the portion of the user audio corresponding to the first sentence, the third sentence, the fifth sentence, the seventh sentence, the ninth sentence, the eleventh sentence, the thirteenth sentence, the fifteenth sentence, the seventeenth sentence and the nineteenth sentence of the 20 lyrics. This portion of the user audio may be synthesized with the portion of the original audio of the target song (which is corresponding to the second, fourth, sixth, eighth, tenth, twelfth, fourteenth, sixteenth, eighth, tenth, twelfth, thirteenth, sixteenth, twenty-seventh sentences of the 20 lyrics) to generate the chorus vocal file of the user.

Through the above process, the portion of the user audio may be synthesized with the portion of the original audio of the target song to generate the chorus vocal file of the user.

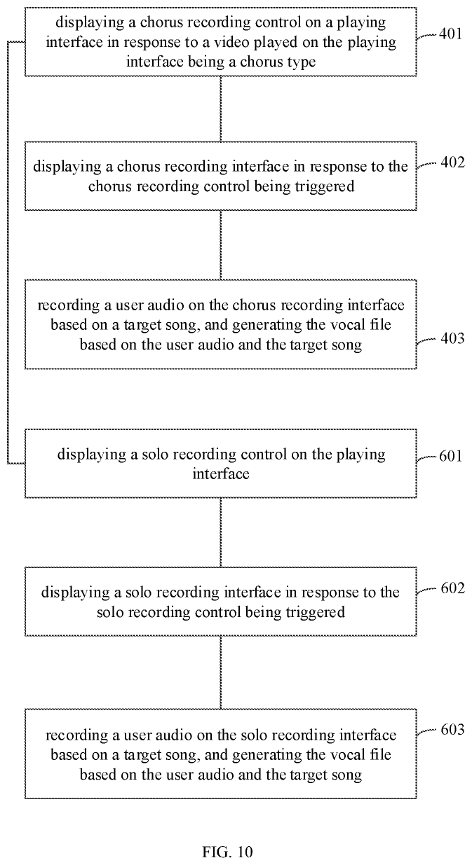

The above analysis shows that when the video is the chorus type, the user may directly enter the chorus recording interface of the target song from the playing interface through the chorus recording control displayed on a certain region of the playing interface, so as to record the chorus singing work of the user. In some embodiments, when the video is the chorus type, the user may enter the solo recording interface of the target song from the playing interface to record the solo singing work of the user. Also, in some embodiments, when the video is the solo type, the user may enter the chorus recording interface of the target song from the playing interface to record the chorus singing work of the user. In view of the above situation, the method for generating the vocal file provided in the embodiments of the disclosure may be further described in conjunction with FIG. 10. It should be understood that the following description take the chorus type as the example, and the embodiments taking the solo type as the example will be obtained from the following description.

FIG. 10 is a flowchart illustrating a method for generating a vocal file according to some embodiments of the disclosure. The method is applicable to an electronic device. The video is the chorus type. As illustrated in FIG. 10, the method may include the following on the basic of the solution as illustrated in FIG. 7.

At block 601, the electronic device can display a solo recording control on the playing interface. That is, the preset solo recording control is displayed in a preset second region on the playing interface, and the preset chorus recording control is displayed in a preset first region on the playing interface.

The preset second region may be located at any position of the playing interface. For example, it may be located at the top position, the bottom position, or the middle position of the playing interface, which is not limited in the embodiments of the disclosure. Also, the preset first region may be located at any position of the playing interface. For example, it may be located at the top position, the bottom position, or the middle position of the playing interface, which is not limited in the embodiments of the disclosure.

In applications, the playing interface may also display other information such as a name and an avatar of the author of the video. The preset second region may be set based on other information that has been displayed in the playing interface. For example, it may be set to be located on the right side of the name of the author of the video on the playing interface, or below the avatar of the author of the video on the playing interface. Also, the preset first region may be set based on other information that has been displayed in the playing interface. For example, it may be set to be located on the right side of the name of the author of the video on the playing interface, or below the avatar of the author of the video on the playing interface.

The solo recording control allows the user to enter the solo recording interface of the target song by touching the control, so as to record the solo singing work. The chorus recording control allows the user to enter the chorus recording interface of the target song by touching the control, so as to record the chorus singing work.

The displaying style of the solo recording control may be set as needed. For example, the solo recording control may be displayed as a round icon with a gray background, an oval icon with a red background, an icon marked with “I want to sing” or “solo”, or other icon, which is not limited in embodiments of the disclosure.

The displaying size of the solo recording control may be set based on factors such as other information already displayed on the playing interface and the size of the screen. For example, when the size of the screen is larger, and the other information displayed on the playing interface is smaller, the displaying size of the solo recording control may be set to be larger. When the size of the screen is smaller, and the other information displayed on the playing interface is smaller, the displaying size of the solo recording control may be set to be smaller.

It is understandable that the video of the chorus type usually includes the audios of two or more persons. In embodiments of the disclosure, when it is detected that the audio of the video played on the interface includes the audios of two or more persons, the type of the video may be determined to be the chorus type. The preset chorus recording control may be displayed on the preset first region of the playing interface. The preset solo recording control may be displayed on the preset second region of the playing interface.

In some embodiments, the video of the solo type includes the user audio, and the video of the chorus type includes the user audio and the original audio. Therefore, in embodiments of the disclosure, the voiceprint recognition technology can recognize the voiceprint feature of the original singer from the video, the type of the video may be determined to be the chorus type. The preset chorus recording control may be displayed on the preset first region of the playing interface. The preset solo recording control may be displayed on the preset second region of the playing interface.

It should be noted that the action at block 601 may be performed at the same time as the action at block 401, or the action at block 601 may be performed first and then the action at block 401 may be performed, or the action at block 401 may be performed first and then the action at block 601 may be performed, which is not limited in the embodiments of the disclosure.

At block 602, the electronic device can display a solo recording interface in response to the solo recording control being triggered. That is, the solo recording interface of the target song is displayed in response to the triggering operation of the user on the solo recording control.

At block 603, the electronic device can record a user audio on the solo recording interface based on the target song, and generate the vocal file based on the user audio and the target song. That is, the user audio is recorded on the solo recording interface based on the audio of the song, and the vocal file of the user is generating by synthesizing corresponding audios accordingly.

The audio of the target song may include the original audio and the accompaniment audio.

It is understandable that under a case that the video is the chorus type, when the user wants to record his/her solo singing work (i.e., his/her solo vocal file) about the target song in the video played on the playing interface, he/she may trigger the solo recording control by clicking, double-clicking, sliding, or long pressing. Therefore, the apparatus for generating the vocal file may respond to the triggering operation of the user on the solo recording control, and display the solo recording interface of the song. Also, when the user wants to record his/her chorus singing work (i.e., his/her chorus vocal file) about the target song in the video played on the playing interface, he/she may trigger the chorus recording control by clicking, double-clicking, sliding, or long pressing. Therefore, the apparatus for generating the vocal file may respond to the triggering operation of the user on the chorus recording control, and display the chorus recording interface of the song.

The displaying mode of the solo recording interface or the chorus recording interface, the manner of recording the user audio based on the audio of the target song on the solo recording interface or the chorus recording interface, and the manner of generating the singing work of the user, may be refer to the description of the above embodiments, which are not repeated herein.

With reference to examples, the method for generating the singing work provided in the embodiments of the disclosure will be described when the video is the chorus type.

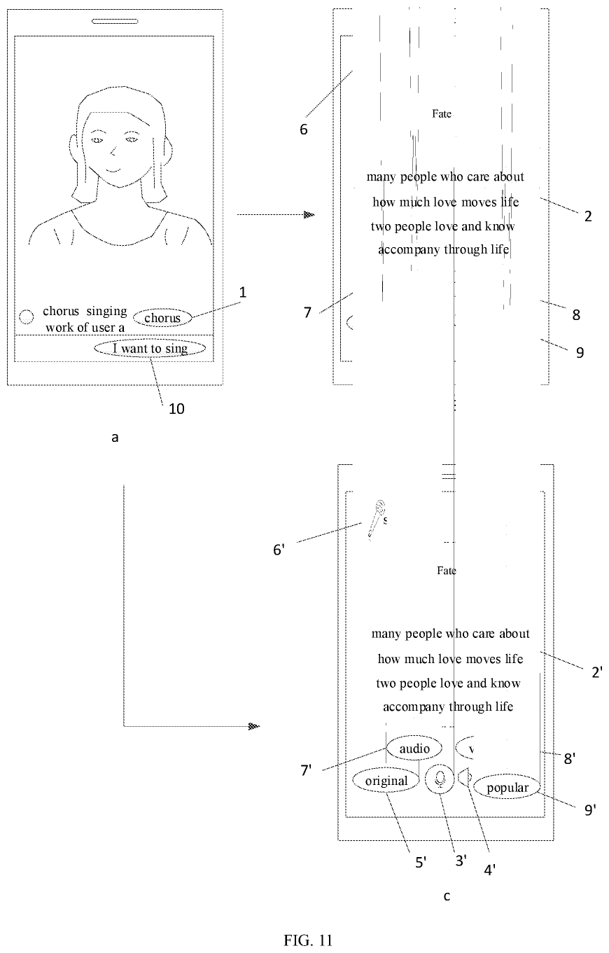

As illustrated in FIG. 11, the chorus video of user a is being played on the video playing interface. When it is detected that the video played on the playing interface is the chorus type, and the target song in the video is “Fate”, the chorus recording control for “Fate” may be displayed at the right side of the playing interface, i.e., the control 1 illustrated in FIG. 11(a). Therefore, the user may enter the chorus recording interface of the target song “Fate” by touching this control, so as to record the chorus singing work on the chorus recording interface. In addition, the solo recording control may be displayed at the lower right corner of the playing interface, i.e., the control 10 illustrated in FIG. 11(a). Therefore, the user may enter the solo recording interface of the target song “Fate” by touching this control, so as to record the solo singing work on the solo recording interface.

The chorus recording interface of the target song “Fate” may be displayed as illustrated in FIG. 11(b) in response to the triggering operation of the user on the control 1. The chorus recording interface of the target song “Fate” may display the switch control for indicating the current recording being recording the chorus singing work, i.e., the control 6 illustrated in FIG. 11(b). The user may learn that the chorus singing work is currently being recorded through the control 6. The chorus recording interface may display the audio-type recording control, i.e., the control 7 in FIG. 11(b).

The chorus recording interface may display the video-type recording control, i.e., the control 8 in FIG. 11(b). Therefore, the user may trigger the control 7 or the control 8 to select to record the chorus singing work of audio type or the chorus singing work of video type. In addition, the name and lyrics of the target song “Fate” may be displayed at the region illustrated by the dotted box 2 in FIG. 11(b), so that the user may complete the singing of the target song based on the displayed lyrics. The recording control of starting or pausing the recording may be illustrated at the bottom of the chorus recording interface, i.e., the control 3 in FIG. 11(b), so that it may start recording the user audio based on the audio of the target song or pausing recording the user audio based on the audio of the target song in response to the triggering operation of the user on the control 3. The chorus recording interface may display the segment recording control, that is, the control 9 in FIG. 11(b), so that the segment of the song, corresponding to the popular segment, may be displayed in response to the triggering operation of the user on the control 9. The adjustment control with the function of adjusting the volume of the audio may also be displayed at the bottom of the chorus recording interface, that is, the control 4 in FIG. 11(b), so that it may control the volume of the audio of the target song in response to the triggering operation of the user on the control 4. The chorus recording interface also display a switch control with the function of turning on or off the original audio, that is, the control 5 in FIG. 11(b), so that it may turn on or off the original audio in response to the triggering operation of the user on the control 5 when the user audio is recorded.

After the user triggers the control 3, closes the original audio by triggering the control 5, and triggers the control 7, the original audio may be closed on the chorus recording interface, while the user audio may be recorded based on the audio of the target song “Fate”. The user audio may be synthesized with the accompaniment audio of the target song “Fate”, and the original audio to generate the chorus singing work of the user. Therefore, the user may directly enter the chorus recording interface of the target song “Fate” from the playing interface by triggering the chorus recording control displayed on the playing interface to record the user audio, so as to generate the chorus singing work of the user.

The solo recording interface of the target song “Fate” may be displayed as illustrated in FIG. 11(c) in response to the triggering operation of the user on the control 10. The solo recording interface of the target song “Fate” may display the switch control for indicating the current recording being recording the solo singing work, i.e., the control 6′ illustrated in FIG. 11(c). The user may learn that the solo singing work is currently being recorded through the control 6′. The solo recording interface may display the audio-type recording control, i.e., the control 7′ in FIG. 11(c). The solo recording interface may display the video-type recording control, i.e., the control 8′ in FIG. 11(c). Therefore, the user may trigger the control 7′ or the control 8′ to select to record the solo singing work of audio type or the solo singing work of video type. In addition, the name and lyrics of the target song “Fate” may be displayed at the region illustrated by the dotted box 2′ in FIG. 11(c), so that the user may complete the singing of the target song based on the displayed lyrics. The recording control of starting or pausing the recording may be illustrated at the bottom of the solo recording interface, i.e., the control 3′ in FIG. 11(c), so that it may start recording the user audio based on the audio of the target song or pausing recording the user audio based on the audio of the target song in response to the triggering operation of the user on the control 3′. The solo recording interface may display the segment recording control, that is, the control 9′ in FIG. 11(c), so that the segment of the song, corresponding to the popular segment, may be displayed in response to the triggering operation of the user on the control 9′. The adjustment control with the function of adjusting the volume of the audio may also be displayed at the bottom of the solo recording interface, that is, the control 4′ in FIG. 11(c), so that it may control the volume of the audio of the target song in response to the triggering operation of the user on the control 4′. The solo recording interface also display a switch control with the function of turning on or off the original audio, that is, the control 5′ in FIG. 11(c), so that it may turn on or off the original audio in response to the triggering operation of the user on the control 5′ when the user audio is recorded.

After the user triggers the control 3′, closes the original audio by triggering the control 5′, and triggers the control 7′, the original audio may be closed on the solo recording interface, while the user audio may be recorded based on the audio of the target song “Fate”. The user audio may be synthesized with the accompaniment audio of the target song “Fate” to generate the solo singing work of the user. Therefore, the user may directly enter the solo recording interface of the target song “Fate” from the playing interface by triggering the solo recording control displayed on the playing interface to record the user audio, so as to generate the solo singing work of the user.

When it is detected that the video played on the playing interface is the chorus type, the preset chorus recording control is displayed on the preset first region of the playing interface, and the preset solo recording control is displayed on the preset second region of the playing interface. The chorus recording interface or the solo recording interface of the target song may be displayed in response to the triggering operation of the user on the chorus recording control or the solo recording control. Therefore, the user may directly enter the solo recording interface from the playing interface through the solo recording control to record the solo singing work, and also may directly enter the chorus recording interface from the playing interface through the solo recording control to record the chorus singing work, which simplifies the path of generating the singing work, enriches types of singing works that can be generated, satisfying the various needs of users.

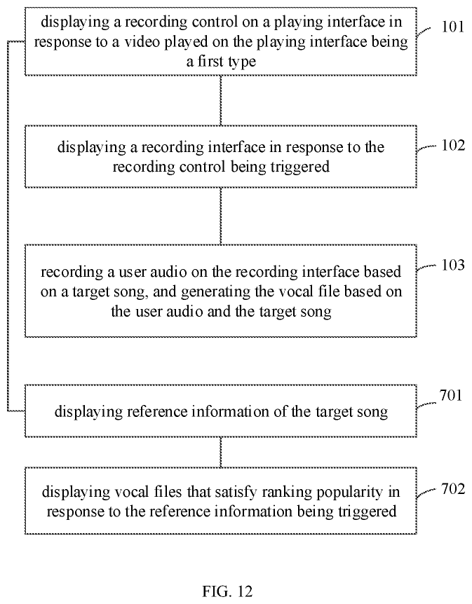

The above analysis shows that when it is detected that the video is the preset singing type, the recording control for the target song in the video may be displayed, so that the user may directly enter the recording interface of the target song from the playing interface, to generate the vocal file of the user. In applications, the user also wants to know some relevant information about the song, such as the name of the target song and other song-related information, as well as how many users have recorded the singing works about this song, and which are popular singing works. Therefore, in embodiments of the disclosure, some related information of the target song may also be displayed. In view of the above situation, in conjunction with FIG. 12, the method for generating the vocal file provided in embodiments of the disclosure may be further described.

FIG. 12 is a flowchart illustrating a method for generating a vocal file according to some embodiments of the disclosure. The method is applicable to an electronic device. As illustrated in FIG. 12, the method may include the following based on the solution as illustrated in FIG. 1.

At block 701, the electronic device can display reference information of the target song. That is, the singing reference information of the target song in the current video is displayed.

The reference information of the target song may include track information of the song, or include the participation information of users, or include both the track information of the target song and the participation information.

The track information may include the name of the song, the original singer, the publication time and other information related to the song.

The participation information may include the number of users who have generated singing works based on the audio of the song, such as “2300 people have sung”, or may include the number of users currently recording singing works based on the audio of the song, such as “2133 people are singing”, etc.

In embodiments, the reference information of the target song may be displayed at any position of the playing interface, for example, at the top position, the bottom position, or the middle position of the playing interface, which is not limited in the disclosure.

In applications, the playing interface may also display other information such as a name and an avatar of the author of the video, and recording control(s). The region located by the reference information may be set based on other information that has been displayed in the playing interface. For example, it may be set to be located on the right side of the name of the author of the video on the playing interface, or below the avatar of the author of the video on the playing interface, or on the left side of the recording control(s).

At block 702, the electronic device can display vocal files that satisfy a ranking popularity in response to the reference information being triggered. That is, the recorded works of the target song that satisfies the preset ranking popularity is displayed in response to the triggering operation of the user on the reference information.

It should be noted that the action at block 701 may be performed simultaneously with the action at block 101, or may performed after or before the action at block 101, which is not limited in the embodiments of the disclosure.

The ranking popularity may be determined based on data such as the number of fans, the number of viewers, the number of likes, and the number of comments. Generally, the more fans, viewers, likes, comments, etc. of the work, the higher the popularity of the work, and the more popular the work; conversely, the lower the popularity of the work, and the less popular the work.

The preset ranking popularity may be set arbitrarily according to needs. For example, when there are more recorded works of the target song that need to be displayed, the preset ranking popularity can be a smaller value, so that there are more recorded works that satisfy the preset ranking popularity; when there are fewer recorded works of the target song that need to be displayed, the preset ranking popularity can be a larger value, so that there are fewer recorded works that satisfy the preset ranking popularity, and so on.

It is understandable that when the user wants to know the popularity of the song, he/she may trigger the reference information by clicking, double-clicking, sliding, or long-pressing the reference information. Therefore, the apparatus for generating the vocal file may respond to the triggering operation of the user on the reference information, and display the recorded works that satisfy the preset ranking popularity.

In embodiments, the recorded works that satisfy the preset ranking popularity may be displayed in a form of list on the recorded work chart page. Furthermore, when the recorded work is displayed, the name of the user to which the recorded work belongs and the popularity may be displayed.

In the following, in conjunction with examples, taking the video as the solo type as an example, the method for generating the vocal file provided in embodiments of the disclosure will be illustrated.

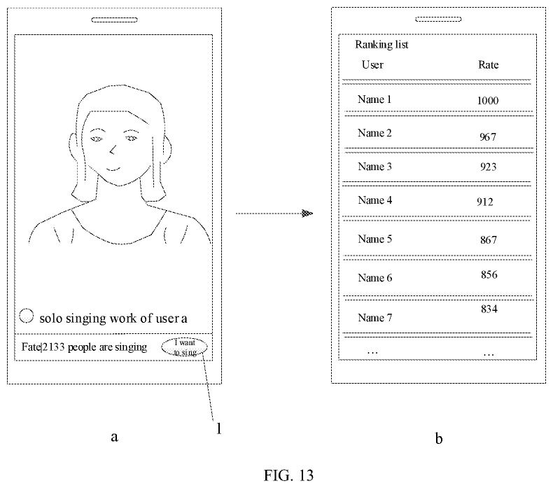

As illustrated in FIG. 13, the solo video of user a is being played on the video playing interface. When it is detected that the video played on the playing interface is the solo type, and the target song in the video is “Fate”, the solo recording control may be displayed at the lower right corner of the playing interface, i.e., the control 1 illustrated in FIG. 13(a). At the same time, in the left of control 1, the reference information of the “Fate” is displayed, i.e., “Fate|2133 people are singing” illustrated in FIG. 13, in which “Fate” is the name of the song, and “2133 people are singing” is the number of users who are currently recording singing works based on the audio of “Fate”. Assuming that there are 50 recorded works of the target song “Fate” and satisfy the preset ranking popularity. When the triggering operation of the user on “Fate|2133 people are singing” is obtained, it may respond to the triggering operation of the user, and 50 recorded works of the target song “Fate”, which satisfy the preset ranking popularity, may be displayed, as illustrated in FIG. 13(b). When the recorded works are displayed, the name of the user to which each recorded work belongs and the popularity of the corresponding work may be displayed.

By displaying the reference information of the song, the user may learn directly about the song-related information of the song, user participation information, etc. from the playing interface, and directly enter the recorded work list page to learn about the popular works in the recorded works of the song. Because there is no need for the user to exit the playing interface, enter the search page to search for the target song and then check the list page of the recorded works of the song, which simplifies the path of entering the list page of recorded works, thereby reducing the operations and saving the user's time and cost.

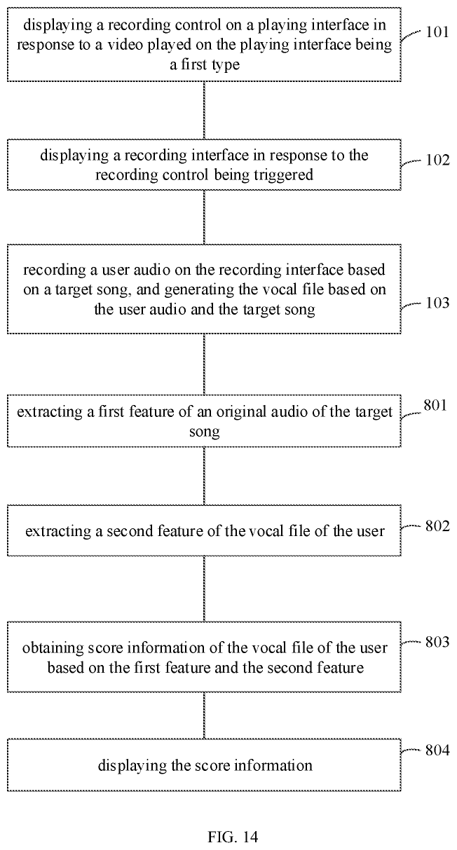

From the above analysis, it may be seen that the method provided in the embodiments of the disclosure, may record the user audio based on the audio of the target song on the recording interface, and generate the singing work of the user based on the user audio and the audio of the song. In applications, after the singing work of the user is generated, the user may also want to know his/her singing level. Therefore, in embodiments of the disclosure, the singing work of the user may be scored. In view of the above situation, the method for generating the singing work provided in embodiments of the disclosure may be describe in conjunction with FIG. 14 in the following.

FIG. 14 is a flowchart illustrating a method for generating a vocal file according to some embodiments of the disclosure. The method is applicable to an electronic device. The method further includes the following after the action at block 103.

At block 801, the electronic device can extract a first feature of an original audio of the target song.

At block 802, the electronic device can extract a second feature of the vocal file of the user.

At block 803, the electronic device can obtain score information of the vocal file of the user based on the first feature and the second feature.

At block 804, the electronic device can display the score information.

It should be noted that the action at block 801 and the action at block 802 may be executed at the same time, or the action at block 801 may be executed first, and then the action at block 802 may be executed, or the action at block 802 may be executed first, and then the action at block 801 may be executed, which is not limited in the embodiments of the disclosure.

The first feature may include the tone of each character of the original singing work of the song, the singing time of each character of the original singing work, and the starting time of each sentence of lyrics, and the like. The second feature may include the tone of each character of the singing work of the user, the singing time of each character of the singing work of the user, the starting time of each sentence of lyrics, and the like.

The score information may include at least one of: a score value and a scoring level of the singing work of the user.

In embodiments, by matching the first feature with the second feature, the score information of the singing work of the user may be determined based on the degree of matching between the first feature and the second feature, and then the score information may be displayed.

In embodiments, the tone of each character of the original singing work may be matched with the tone of each character of the singing work of the user, and the first score of the singing work of the user may be determined according to the matching result. The singing time of each character of the original singing work may be matched with the singing time of each character of the singing work of the user, and the second score of the singing work of the user may be determined according to the matching result. The starting time of each sentence of lyrics of the original singing work may be matched with the starting time of each sentence of lyrics of the singing work of the user, and the third score of the singing work of the user may be determined according to the matching result. The score of the singing work of the user may be obtained based on the first score, the second score and the third score.

In addition, scores corresponding to different scoring levels can be preset, so that the scoring level of the singing work of the user may be determined based on the score. For example, 90-100 points may be set to correspond to the scoring level SSS, 70-90 points may be set to correspond to the scoring level SS, 60-70 points may be set to correspond to the scoring level S, 50-60 points may be set to correspond to the scoring level A, 40-50 points may be set to correspond to the scoring level B, points below 40 points may be set to correspond to the scoring level C. Therefore, if the score of the singing work of the user is 95 points, it may be determined that the corresponding scoring level is SSS.

Thus, the tone of each character of the original singing work may be matched with the tone of each character of the singing work of the user, the singing time of each character of the original singing work may be matched with the singing time of each character of the singing work of the user, and the starting time of each sentence of lyrics of the original singing work may be matched with the starting time of each sentence of lyrics of the singing work of the user. Therefore, the score information of the singing work of the user may be determined based on the comparison results, thereby obtaining the score information of the singing work of the user accurately and comprehensively.

In embodiments, the display position of the score information may be set arbitrarily as required. For example, after obtaining the score information of the singing work of the user, it may enter the score information displaying interface, and the score information may be displayed at the preset region on the score information displaying interface.

The preset region may be located at any position of the score information displaying interface. For example, it may be located at the top position, the bottom position, or the middle position of the score information displaying interface, which is not limited in the embodiments of the disclosure.

In some embodiments, after obtaining the score information of the singing work of the user, the score information may be directly displayed on the recording interface of the song. The score information may be displayed on the recording interface with a preset transparency. For example, the score information may be displayed semi-transparently on the recording interface, so that the score information may be clearly displayed, while the displaying of the recording interface will not be blocked.

In the following, in conjunction with examples, taking the video as the solo type as an example, the method provided in the embodiments of the disclosure will be illustrated.

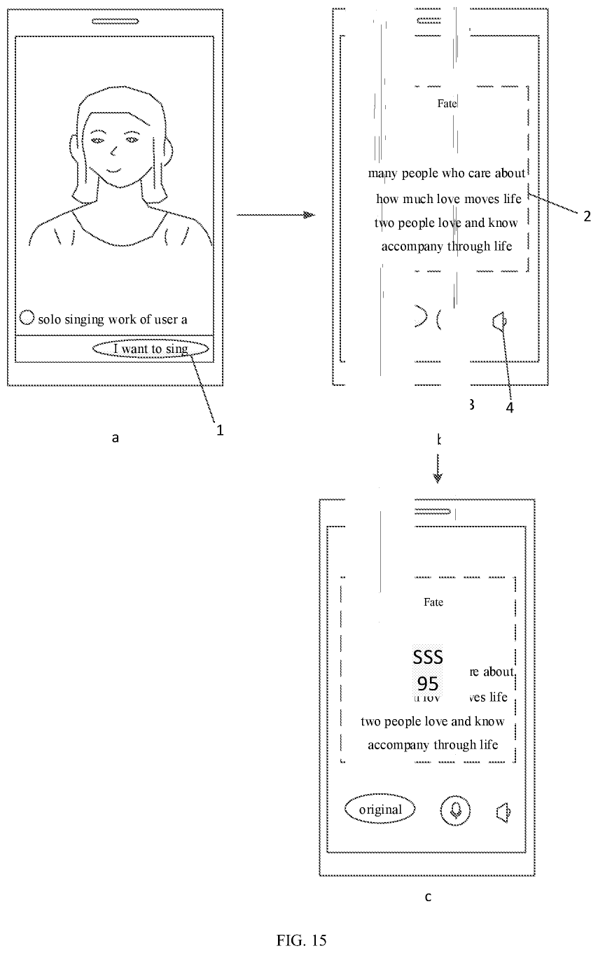

As illustrated in FIG. 15, the solo video of user a is being played on the video playing interface. When it is detected that the video played on the playing interface is the solo type, and the target song in the video is “Fate”, the solo recording control may be displayed at the lower right corner of the video playing interface, i.e., the control 1 illustrated in FIG. 15(a).

The solo recording interface of the target song “Fate” may be displayed as illustrated in FIG. 15(b) in response to the triggering operation of the user on the control 1. In addition, the name and lyrics of the target song “Fate” may be displayed at the region illustrated by the dotted box 2 in FIG. 15(b), so that the user may complete the singing of the target song based on the displayed lyrics. The recording control of starting or pausing the recording may be illustrated at the bottom of the solo recording interface, i.e., the control 3 in FIG. 15(b), so that it may start recording the user audio based on the audio of the target song or pausing recording the user audio based on the audio of the target song in response to the triggering operation of the user on the control 3. The adjustment control with the function of adjusting the volume of the audio may also be displayed at the bottom of the solo recording interface, that is, the control 4 in FIG. 15(b), so that it may control the volume of the audio of the target song in response to the triggering operation of the user on the control 4. The solo recording interface also display a switch control with the function of turning on or off the original audio, that is, the control 5 in FIG. 15(b), so that it may turn on or off the original audio in response to the triggering operation of the user on the control 5 when the user audio is recorded.

After the user triggers the control 3 in FIG. 15(b), the user audio may be recorded based on the audio of the target song “Fate”. The user audio may be synthesized with the accompaniment audio of the target song “Fate” to generate the solo singing work of the user.

After the singing work of the user is generated, the first feature of the original singing work of “Fate” and the second feature of the singing work of the user may be extracted. The score and the scoring level of the singing work of the user may be obtained based on the first feature and the second feature. If the score of the singing work of the user is 95 points and the scoring level is SSS, as illustrated in FIG. 15, the score information of the singing work of the user may be displayed on the recording interface.

After the singing work of the user is generated, the first feature of the original singing work of “Fate” and the second feature of the singing work of the user may be extracted. The score information of the singing work of the user is obtained based on the first feature and the second feature, and the score of the singing work of the user may be displayed directly after the user completes the singing work. In some embodiments, the above-mentioned method may enable the user directly understand his/her singing level after completing the singing work, and then improve his/her singing level.

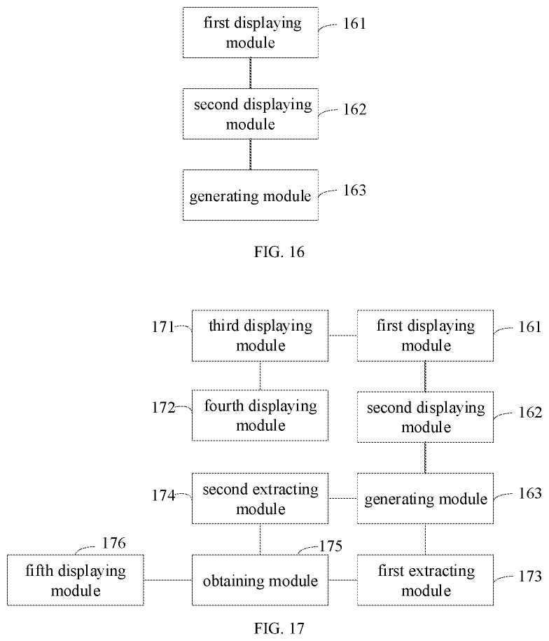

FIG. 16 is a block diagram illustrating an apparatus for generating a vocal file according to some embodiments of the disclosure.

As illustrated in FIG. 16, the apparatus includes a first displaying module 161, a second displaying module 162, and a generating module 163.

It should be noted that the apparatus provided in the embodiments of the disclosure may execute the method in the foregoing embodiments. The apparatus provided in the embodiments of the disclosure may configured in an electronic device to simplify the path of generating the singing work, thereby reducing the operations and saving the user's time and cost.

The electronic device may be any stationary or mobile computing device with a screen and a microphone. The computing device can process data. The mobile computing device may be such as a notebook computer, a smart phone, and a wearable device. The stationary computing device may be such as a desktop computer or any of other types of computing device. The apparatus for generating the vocal file may be an application program installed in the electronic device, such as Karaoke software, or a web page or application program for managing and maintaining Karaoke software by managers and developers, which is not limited in embodiments of the disclosure.

The first displaying module 161 is configured to display a recording control on a playing interface in response to a video played on the playing interface being a first type.

The second displaying module 162 is configured to display a recording interface in response to the recording control being triggered.

The generating module 163 is configured to record a user audio on the recording interface based on an audio of a target song in the video; and generate the vocal file based on the user audio and the audio of the song.

FIG. 16 is a block diagram illustrating an apparatus for generating a vocal file according to some embodiments of the disclosure. The apparatus includes further includes a third displaying module 171, a fourth displaying module 172, a first extracting module 173, a second extracting module 174, an obtaining module 175, and a fifth displaying module 176.

The third displaying module 171 is configured to display reference information of the song.

The fourth displaying module 172 is configured to display vocal files that satisfy a ranking popularity in response to the reference information being triggered.

The first extracting module 173 is configured to extract a first feature of an original audio of the song.

The second extracting module 174 is configured to extract a second feature of the vocal file of the user.

The obtaining module 175 is configured to obtain score information of the vocal file of the user based on the first feature and the second feature.

The fifth displaying module 176 is configured to display the score information.

In some embodiments, the reference information includes track information of the song, and/or participation information.

In some embodiments, under a case that the first type includes a solo type, the first displaying module 161 includes a first displaying unit, and the second displaying module 162 includes a second displaying unit. The first displaying unit is configured to display a solo recording control on the playing interface. The second displaying unit is configured to display a solo recording interface in response to the solo recording control being triggered.

In some embodiments, under a case that the first type includes a chorus type, the first displaying module 161 includes a third displaying unit, and the second displaying module 162 includes a fourth displaying unit. The third displaying unit is configured to display a chorus recording control on the playing interface. The second displaying unit is configured to display a chorus recording interface in response to the chorus recording control being triggered.

Regarding the apparatus according to the foregoing embodiments, the specific manner in which each module performs operations has been described in detail in embodiments of the method, and thus detailed description will not be repeated here.

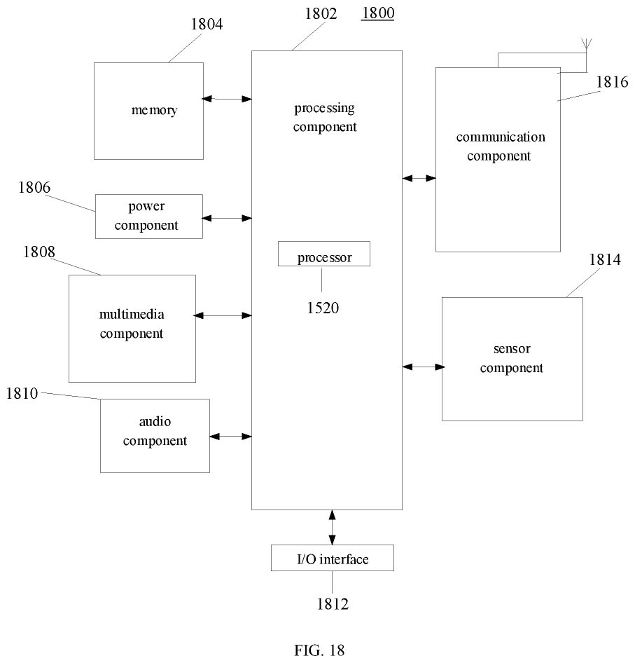

FIG. 18 is a block diagram illustrating an electronic device 1800 according to some embodiments. For example, the device 1800 may be a mobile phone, a computer, a digital broadcast terminal, a messaging device, a game console, a tablet device, a medical device, an exercise device, a personal digital assistant, and the like.

Referring to FIG. 18, the device 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 normally controls the overall operation (such as operations associated with displaying, telephone calls, data communications, camera operations and recording operations) of the device 1800. The processing component 1802 may include one or more processors 1820 to execute instructions so as to perform all or part of the actions of the above described method. In addition, the processing component 1802 may include one or more units to facilitate interactions between the processing component 1802 and other components. For example, the processing component 1802 may include a multimedia unit to facilitate interactions between the multimedia component 1808 and the processing component 1802.

The memory 1804 is configured to store various types of data to support operations at the device 1800. Examples of such data include instructions for any application or method operated on the device 1800, contact data, phone book data, messages, images, videos and the like. The memory 1804 may be realized by any type of volatile or non-volatile storage devices, or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk.

The power component 1806 provides power to various components of the device 1800. The power component 1806 may include a power management system, one or more power sources and other components associated with power generation, management, and distribution of the device 1800.

The multimedia component 1808 includes a screen that provides an output interface between the device 1800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may sense not only the boundary of the touches or sliding actions, but also the duration and pressure related to the touches or sliding operations. In some embodiments, the multimedia component 1808 includes a front camera and/or a rear camera. When the device 1800 is in an operation mode such as a shooting mode or a video mode, the front camera and/or the rear camera may receive external multimedia data. Each front camera and rear camera may be a fixed optical lens system or have a focal length and an optical zoom capability.

The audio component 1810 is configured to output and/or input an audio signal. For example, the audio component 1810 includes a microphone (MIC) that is configured to receive an external audio signal when the device 1800 is in an operation mode such as a call mode, a recording mode, and a voice recognition mode. The received audio signal may be further stored in the memory 1804 or transmitted via the communication component 1816. In some embodiments, the audio component 1810 further includes a speaker for outputting audio signals.

The I/O interface 1812 provides an interface between the processing component 1802 and a peripheral interface unit. The peripheral interface unit may be a keyboard, a click wheel, a button and so on. These buttons may include, but are not limited to, a home button, a volume button, a start button, and a locking button.

The sensor component 1814 includes one or more sensors for providing the device 1800 with various aspects of status assessments. For example, the sensor component 1814 may detect an ON/OFF state of the device 1800 and a relative positioning of the components. For example, the components may be a display and a keypad of the device 1800. The sensor component 1814 may also detect a change in position of the device 1800 or a component of the device 1800, the presence or absence of contact of the user with the device 1800, the orientation or acceleration/deceleration of the device 1800 and a temperature change of the device 1800. The sensor component 1814 may include a proximity sensor configured to detect the presence of nearby objects without any physical contact. The sensor component 1814 may also include a light sensor (such as a CMOS or a CCD image sensor) for use in imaging applications. In some embodiments, the sensor component 1814 may further include an acceleration sensor, a gyro sensor, a magnetic sensor, a pressure sensor, or a temperature sensor.

The communication component 1816 is configured to facilitate wired or wireless communication between the device 1800 and other devices. The device 1800 may access a wireless network based on a communication standard such as 2G, 3G, 4G, 5G or a combination thereof. In some embodiments, the communication component 1816 receives broadcast signals or broadcast-associated information from an external broadcast management system via a broadcast channel. In some embodiments, the communication component 1816 further includes a near field communication (NFC) module to facilitate short range communication. For example, the NFC module may be implemented based on radio frequency identification (RFID) technology, infrared data association (IrDA) technology, ultra-wide band (UWB) technology, Bluetooth (BT) technology and other technologies.

In some embodiments, the device 1800 may be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, or other electronic components, so as to perform the above image conversion method.

In some embodiments, there is also provided a non-transitory computer readable storage medium including instructions, such as a memory 1804 including instructions. The instructions are executable by the processor 1820 of the device 1800 to perform the above method. For example, the non-transitory computer readable storage medium may be a ROM, a random-access memory (RAM), a CD-ROM, a magnetic tape, a floppy disk, an optical data storage device, etc.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for generating a vocal file, comprising:
displaying a recording control on a playing interface in response to a video being a first type, wherein the video is played on the playing interface;
displaying a recording interface in response to the recording control being triggered;
recording a user audio on the recording interface based on a target song; and
generating the vocal file based on the user audio and the target song.

2. The method as claimed in claim 1, further comprising:
displaying a segment recording control on the recording interface; and
displaying a segment of the target song in response to the segment recording control being triggered.

3. The method as claimed in claim 1, wherein the recording control comprises a solo recording control and the recording interface comprises a solo recording interface in response to the first type being a solo type.

4. The method as claimed in claim 1, wherein the recording control comprises a chorus recording control and the recording interface comprises a chorus recording interface in response to the first type being a chorus type.

5. The method as claimed in claim 4, said recording the user audio on the recording interface based on the target song, and generating the vocal file based on the user audio and the target song, comprising:
recording a portion of the user audio on the recording interface based on an accompaniment audio of the target song; and
generating the vocal file based on the portion of the user audio and a portion of an original audio of the target song.

6. The method as claimed in claim 1, further comprising:
displaying a solo recording control and a chorus recording control on the playing interface; and
displaying a solo recording interface in response to the solo recording control being triggered; and
displaying a chorus recording interface in response to the chorus recording control being triggered.

7. The method as claimed in claim 1, wherein the recording control comprises: an audio-type recording control or a video-type recording control.

8. The method as claimed in claim 1, further comprising:
displaying reference information of the song; and
displaying vocal files that satisfy a ranking popularity in response to the reference information being triggered.

9. The method as claimed in claim 8, wherein the reference information comprises track information of the song, and/or participation information.

10. The method as claimed in claim 1, further comprising:
extracting a first feature of an original audio of the song;
extracting a second feature of the vocal file of the user;
obtaining score information of the vocal file of the user based on the first feature and the second feature; and
displaying the score information.

11. An electronic device, comprising:
a processor; and
a storage device for storing executable instructions,
wherein the processor is configured to execute instructions to:
display a recording control on a playing interface in response to a video being a first type,
wherein the video is played on the playing interface;
display a recording interface in response to the recording control being triggered;
record a user audio on the recording interface based on a target song; and
generate the vocal file based on the user audio and the target song.

12. The device as claimed in claim 11, wherein the processor is further configured to execute the instructions to:
display a segment recording control on the recording interface; and
display a segment of the target song in response to the segment recording control being triggered.

13. The device as claimed in claim 11, wherein the recording control comprises a solo recording control and the recording interface comprises a solo recording interface in response to the first type being a solo type.

14. The device as claimed in claim 11, wherein the recording control comprises a chorus recording control and the recording interface comprises a chorus recording interface in response to the first type being a chorus type.

15. The device as claimed in claim 14, wherein the processor is further configured to execute the instructions to:
record a portion of the user audio on the recording interface based on an accompaniment audio of the target song; and
generate the vocal file based on the portion of the user audio and a portion of an original audio of the target song.

16. The device as claimed in claim 11, wherein the processor is further configured to execute the instructions to:
display a solo recording control and a chorus recording control on the playing interface; and
display a solo recording interface in response to the solo recording control being triggered; and
display a chorus recording interface in response to the chorus recording control being triggered.

17. The device as claimed in claim 11, wherein the recording control comprises: an audio-type recording control or a video-type recording control.

18. The device as claimed in claim 11, wherein the processor is further configured to execute the instructions to:
display reference information of the song; and
display vocal files that satisfy a ranking popularity in response to the reference information being triggered.

19. The device as claimed in claim 11, wherein the processor is further configured to execute the instructions to:
extract a first feature of an original audio of the song;
extract a second feature of the vocal file of the user;
obtain score information of the vocal file of the user based on the first feature and the second feature; and
display the score information.

20. A non-transitory computer-readable storage medium having stored therein instructions that, when executed by a processor of an electronic device, causes the electronic device to perform a method for generating a vocal file, the method comprising:
displaying a recording control on a playing interface in response to a video being a first type, wherein the video is played on the playing interface;
displaying a recording interface in response to the recording control being triggered;
recording a user audio on the recording interface based on a target song; and
generating the vocal file based on the user audio and the target song.
